(19) United States
(12) Patent Application Publication
(10) Pub. No.: US 2010/0262987 A1
(43) Pub. Date: Oct. 14, 2010

(54) Method And System For Synergistic Integration Of Broadcasting And Personal Channels

(76) Inventor: Benjamin Imanilov, Petah (IL)

Correspondence Address: MCANDREWS HELD & MALLOY, LTD, 500 WEST MADISON STREET, SUITE 3400, CHICAGO, IL, 60661, US

(21) Appl. No.: 12/422,614

(22) Filed: Apr. 13, 2009

(51) Int. Cl. H04H 60/33; H04N 7/173; H04N 7/025

(52) U.S. Cl. 725/9; 725/133; 725/35

(57) ABSTRACT

A communication device may receive broadcast signals and personal communication signals and may interleave and/or combine the broadcast content and personal communication content. The interleaved and/or combined content may be displayed and/or played as a single stream of video and/or audio. The personal communication content may comprise directed advertisement and/or other specified content which may be determined based on a user's location and/or a user profile. Advertisements may be monitored. The broadcast signals may comprise radio and/or TV programs and may be received via terrestrial wireless, satellite, cable and/or Internet channels. The personal communication signals may be transmitted and/or received via cellular, personal cable, personal satellite and/or a personal Internet channels. The user may respond via the personal communication signals. Broadcast and/or personal communication signals may be deciphered. Deciphering keys and/or information may be received via the personal communication signals.

### CROSS-REFERENCE TO RELATED APPLICATIONS/INCORPORATION BY REFERENCE

[Not Applicable]

### FIELD OF THE INVENTION

Certain embodiments of the invention relate to communication. More specifically, certain embodiments of the invention relate to a method and system for synergistic integration of broadcasting and personal channels.

### BACKGROUND OF THE INVENTION

With the popularity of portable electronic devices and wireless devices that support audio and/or video applications, there is a growing demand to provide a simple and complete solution. Some wireless devices may have the capability to handle a plurality of protocols and may comprise a plurality of processing hardware and/or processing software. In addition, wireless devices today may support a plurality of radio communication standards for a variety of radio technologies that may be implemented by multiple technology or multi-mode devices. Reception and/or transmission of data to and/or from these mobile wireless devices may require significant processing overhead that may impose certain operation restrictions and/or design challenges.

Some multi-mode devices may comprise Bluetooth technology, for example, which may enable transmission and reception of signals to wireless and/or wired devices such as headphones and/or speakers. Bluetooth technology may allow users to hear and/or view audio and/or video data with their wireless handset while freeing users to perform other activities. Other users may have portable electronic devices that may enable them to play stored audio content and/or receive audio content via broadcast communication, for example.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for synergistic integration of broadcasting and personal channels, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating a plurality of exemplary communication devices that are enabled to receive broadcast and/or personal communication, in accordance with an embodiment of the invention.

FIG. 2 is a block diagram illustrating an exemplary single chip with multiple integrated radios that supports radio broadcast and personal communications coordination, in accordance with an embodiment of the invention.

FIG. 3 is a block diagram illustrating an exemplary chip that may be operable to coordinate broadcast and personal communication, in accordance with an embodiment of the invention.

FIG. 4 is a block diagram illustrating an exemplary user device that is operable to coordinate broadcast radio and personal radio communication, in accordance with an embodiment of the invention.

FIG. 5 is a block diagram illustrating an exemplary stream of interleaved broadcast data and personal personally directed data, in accordance with an embodiment of the invention.

FIG. 6 is a flow chart illustrating exemplary steps for integrating broadcast content and personal communication content in a multimode device, in accordance with an embodiment of the invention.

### DETAILED DESCRIPTION OF THE INVENTION

Certain aspects of the invention may be found in a method and system for synergistic integration of broadcasting and personal channels. One or more processors or circuits in a communication device may receive broadcast signals and personal communication signals, wherein the personal communication signals may be unicasted to the communication device. The one or more processors or circuits may be operable to interleave and/or combine broadcast content from the broadcast signals with personal communication content from the received personal communication signals. In this regard, portions of the personal communication content may be inserted in the broadcast content. The interleaved and/or combined broadcast content and personal content may be displayed and/or played as a single stream of video and/or audio. In addition, the interleaved and/or combined content may be transmitted to as second user device, for example, via Bluetooth to be played by the second device. The personal communication content may be determined and/or selected based on a location of the communication device and/or based on demographics of a user and/or a profile associated with the user. The broadcast signals may be received via one or more of a digital and/or analog terrestrial radio band and/or television channel, a satellite radio and/or television channel, a cable radio and/or television channel, and Internet radio and/or video channel, for example. The personal communication signals may be received via one or more of a cellular channel, a personal cable channel, a personal satellite channel and/or a personal Internet channel, for example. Exemplary broadcast content may comprise a television and/or radio program, for example, a music or a news program. Exemplary personal communication content may comprise advertising directed to an individual user or a group of users. The user may be able to transmit feedback and/or a response via the personal communication signals. In various embodiments of the invention, broadcast signals and/or personal communication signals may be received and/or deciphered. Deciphering keys and/or information may be received via the personal communication signals. Moreover, exemplary embodiments of the invention may be operable to monitor and/or count advertisements received via the personal communication signals. In this manner, a user may receive broadcast content interleaved with content that may be received via a personal channel.

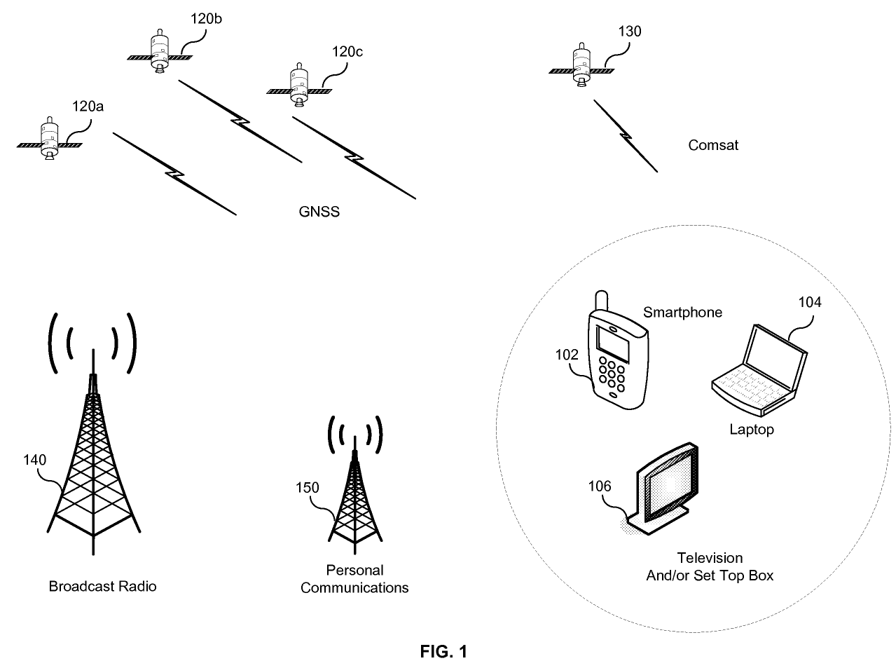

FIG. 1 is a block diagram illustrating a plurality of exemplary communication devices that are enabled to receive broadcast and/or personal communication, in accordance with an embodiment of the invention. Referring to FIG. 1, there is shown a cellular phone 102, a laptop 104, a set-top-box 106, global navigation satellite system (GNSS) satellites 120a, 120b and 120c, a communication satellite 130, a broadcast transmission system 140 and a personal communication system 150.

The communication satellite 130 may comprise suitable logic, circuitry and/or code that may be operable to communicate radio, television, Internet and/or telephony content to other stations and/or to devices. For example, television and/or radio programs may be broadcast via the communication satellite 130. The broadcast transmission system 140 may be a terrestrial communication system that may communicate radio, television, internet and/or telephony content to other stations and/or devices. For example, the broadcast transmission system 140 may broadcast FM radio signals and/or television signals.

The personal communication system 150 may be, for example, a cellular or WiFi system that may communicate via a channel dedicated to a specified user and/or specified device. For example, cellular and/or WiFi channels may enable personal communication. In this regard, cellular channels may be utilized to communicate with a smart phone, a laptop or any suitable device that may comprise a cellular transceiver.

The cellular phone 102, the laptop 104 and/or the set-top-box 106 may comprise suitable logic circuitry, interfaces and/or code that may be operable to receive broadcast signals as well as signals communicated via a personal communication channel, for example, signals communicated to a specified individual and/or a specified device. These devices may be capable of multimode communication and may each comprise a plurality of transmitters and/or receivers. For example, one or more of the cellular phone 102, the laptop 104 and the set-top-box 106 may be operable to receive broadcast signals from one or more sources. For example, the cellular phone 102, the laptop 104 and/or the set-top-box 106 may receive FM signals from the broadcast transmission system 140, broadcast satellite television signals from the communication satellite 130, broadcast cable television signals, broadcast cellular signals from the personal communication system 150 and/or internet broadcasts for example. In addition, one or more of the cellular phone 102, the laptop 104 and/or the set-top-box 106 may be operable to communicate via a personal communication channel. For example, the personal communication system 150 may direct communication to a specific user or group of users or to a specified device or group of devices. In this regard, the personal communication may comprise cellular voice communication and/or cellular data communication. SMS messages may be utilized to deliver personal information to a specified user. In addition, satellite television signals via the communication satellite 130, cable television signals, WiFi, WLAN and/or LAN communications, for example, may enable personal communication directed to one or more specified individuals, specified devices and/or specified groups of individuals and/or devices. Although FIG. 1 comprises a cellular phone, a laptop and a set-top-box, the invention is not so limited and may be embodied in any suitable wired and/or wireless communication device.

The cellular phone 102, the laptop 104 and/or the set-top-box 106 may comprise suitable logic, circuitry, interfaces and/or code that may be operable to render and/or display multimedia data. The multimedia data may comprise still and/or motion images such as video and/or audio information. For example, the cellular phone 102, the laptop 104 and/or the set-top-box 106 may comprise speakers and/or a display. In addition, the cellular phone 102, the laptop 104 and/or the set-top-box 106 may comprise a user interface, for example, a keypad, touch screen, voice activation and/or pressure activation interface for inputting user information. Moreover, the cellular phone 102, the laptop 104 and/or the set-top-box 106 may comprise suitable logic, circuitry, interfaces and/or code that may be operable to communicate received communication data to a remote device, for example, a Bluetooth enabled device. In addition, an HDMI enabled device and/or a car radio system, for example, may be operable to receive the communication data.

The cellular phone 102, the laptop 104 and/or the set-top-box 106 may comprise suitable logic circuitry and/or code that may be operable to coordinate the rendering and/or display of broadcast data with the rendering and/or display of personal communication data. In this regard, the cellular phone 102, the laptop 104 and/or the set-top-box 106 may be operable to switch between sources of communication data in a manner that may appear seamless and/or transparent to a user. Broadcast content and personally directed content may be presented to the user as a single form of communication. In an exemplary embodiment of the invention, radio listeners may receive an FM radio broadcast via the broadcast transmission system 140 and, for example, the cellular phone 102. The FM radio broadcast may comprise music, audio content such as talk show content, and/or news programming for example. The FM radio broadcast may also comprise HD FM content and/or RDS content. During the broadcast program, for example, during advertising segments of the program, the cellular phone may substitute content received via a personal communication channel for the content received via the broadcast channel. For example, advertising content, news of interest to the user, stock reports and/or local weather may be received from the personal communication system 150 via cellular signals that may be directed to the user of the cellular phone 102. After the user directed content is played, the cellular phone 102 may return to playing the broadcast program content that may be received via the broadcast transmission system 140.

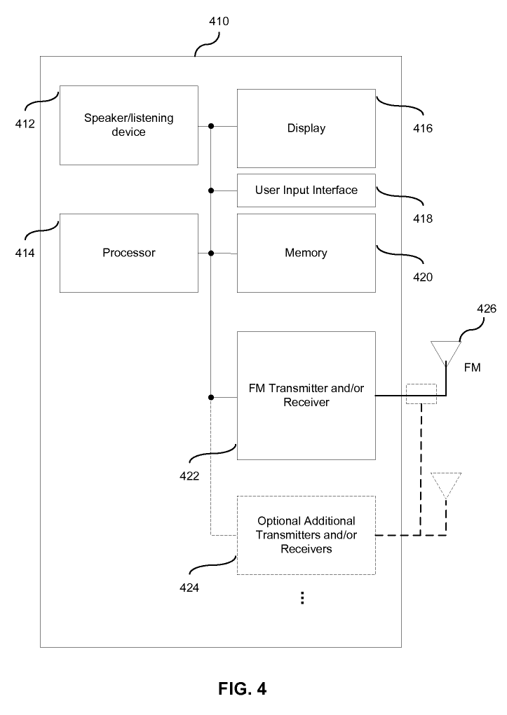

The cellular signals may comprise directed content such as advertising, news programs or local weather that may be directed to a specific user or group of users. For example, the directed content may be determined based on demographics of a user or a group of users. In some embodiments of the invention, the directed advertising may be determined based on the location of a user or device. For example, the cellular phone 102 may comprise a GNSS receiver that may provide location information. The location information may be utilized to select advertising content that may be appropriate or targeted for a user's location and/or a user's preference. Other information may be utilized to determine which content should be sent to a user. For example, a user may be allowed to specify their preference(s) for various advertising content and/or for various types of news programming. A user profile that may indicate the user's preferences may be stored in the cellular phone 102 or, for example, stored by a personal communication service provider. The user preferences may be determined or modified utilizing the cellular phone 102 via a personal channel while a user may be viewing and/or listening to a broadcast and/or to directed advertising. Moreover, the user preferences may be pre-determined and/or stored prior to utilizing the cellular phone 102. The directed content may be received in real time during the broadcast and/or may be stored in the cellular phone 102 until needed. In addition, the user or listener may be enabled to respond to the directed content such as advertising via a user interface (shown in FIG. 4) and the personal communication system 150. In this manner, personal communication service providers may be enabled to bill for advertisements that are communicated to users of the coordinated broadcast and personal communication application.

The set-top-box 106 may be a multimode device that may comprise a plurality of transmitters and/or receivers. For example, the set-top-box 106 may comprise a satellite television receiver that may be operable to receive wireless or wired television broadcast signals. The set-top-box 106 may also comprise a cable transmitter and/or receiver that may enable the set-top-box 106 to receive data via a broadcast channel, a multicast channel and/or a personal channel. In addition, the set-top-box may be operable to send data to a head-end via a personal channel on the cable. In addition, the set-top-box 106 may comprise a GNSS receiver and may be operable to determine its location. The set-top-box 106 may comprise suitable logic, circuitry, interfaces and/or code that may be operable to switch between receiving broadcast transmissions, for example, from the communication satellite 130 and communicating via a personal channel, for example, via the cable system. In other exemplary embodiments of the invention, the set-top-box 106 may be operable receive broadcasting, multicasting and/or personal communication via the cable system.

In operation, switching between broadcast reception and personal communication in the cellular phone 102, the laptop 104 and/or the set-top-box 106 may be performed without user input. In an exemplary embodiment of the invention, a user may be viewing a broadcast program via the set-top-box 106. For example, the user may be viewing a news program. At a particular time instant, the news program may break for an advertisement. During the advertisement break, the set-top-box 106 may switch its source of signal to a personal channel via a cable, for example. The set-top-box 106 may receive advertising or information on a topic of interest that may be tailored for a specific user or household. In this manner, a plurality of users and/or devices that may be receiving the same news program via the same television satellite broadcast system 130, may each receive different advertisements via a personal communication channel.

In various embodiments of the invention, a personal communication system, for example, the personal communication system 150 may be operable to broadcast data on one personal communication channel that may be received by a plurality of subscribers and may alternately transmit data directed to individual subscribers on a plurality of personal communication channels. In this manner, a subscriber may seamlessly receive alternating broadcast data and personally directed data.

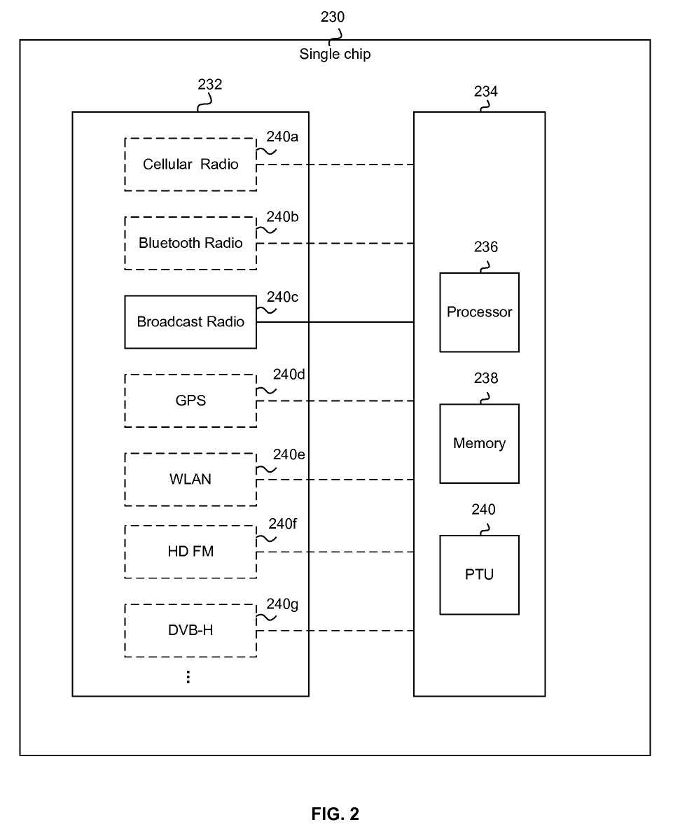

FIG. 2 is a block diagram illustrating an exemplary single chip with multiple integrated radios that supports radio broadcast and personal communications coordination, in accordance with an embodiment of the invention. Referring to FIG. 2, there is shown a single chip 230 that may comprise a radio portion 232 and a processing portion 234. The radio portion 232 may comprise a plurality of integrated radios. For example, the radio portion 232 may comprise a broadcast radio 240c that may handle FM broadcasts and/or video broadcasts and a plurality of optional integrated. The radio portion 232 may comprise one or more of a cellular radio 240a that supports cellular communications, a Bluetooth radio 240b that supports Bluetooth communications, a global positioning system (GPS) 240d that supports GPS communications, a wireless local area network (WLAN) 240e that supports communications based on one or more of the IEEE 802.11 standards, HD radio 240f and DVB-H radio 240g.

The processing portion 234 may comprise at least one processor 236, a memory 238, and a peripheral transport unit (PTU) 240. The processor 236 may comprise suitable logic, circuitry, interfaces and/or code that enable processing of data received from the radio portion 232. In this regard, each of the integrated radios may communicate with the processing portion 234. In some instances, the integrated radios may communicate with the processing portion 234 via a common bus, for example. The memory 238 may comprise suitable logic, circuitry, interfaces and/or code that enable storage of data that may be utilized by the processor 236. The memory 238 may store at least a portion of the data received by at least one of the integrated radios in the radio portion 232. Moreover, the memory 238 may store at least a portion of the data that may be transmitted by at least one of the integrated radios in the radio portion 232. The memory 238 may be operable to store instructions for processing and/or coordinating data received by one or more of the radios in the radio portion 232. The PTU 240 may comprise suitable logic, circuitry, interfaces and/or code that may enable interfacing data in the single chip 230 with other devices that may be communicatively coupled to the single chip 230. In this regard, the PTU 240 may support analog and/or digital interfaces.

In operation, the single chip 230 may be implemented in a multi-mode communication device, for example, the cellular phone 102, the laptop 104 and/or the set-top-box 106 described with respect to FIG. 1. The single chip 230 may be operable to receive broadcast signals via the broadcast radio 240c. For example the broadcast radio 240c may comprise an FM receiver or a television receiver. In addition, the single chip 230 may be operable to communicate via the cellular radio 240a. In this regard, the radio portion 232 and/or the processing portion 234 may be operable to coordinate switching between receiving and/or processing data from the broadcast radio 240c and one or more of the personal communication radios, for example, the cellular radio 240a. For example, the single chip 230 may receive a stream of multimedia data and/or RDS data via the broadcast radio 240c and may switch to receiving and/or transmitting multimedia data to and/or from the cell radio 240a. The switching may occur based on information imbedded in the received signals and/or may be based on timing or configuration parameters within the processing portion 234 of the single chip 230. The multimedia data received via the broadcast radio 240c and the multimedia data received via the cellular radio 240a may be coordinated, integrated, interleaved and/or alternated by the processor 236 and may be presented to a user as one single stream of data via a listening device and/or display. The single chip 230 may be operable to transmit signals via the cellular radio 240a, for example, that a user may input as a response to received multimedia data. In various embodiment of the invention, radios in the radio portion 232 and/or the components in the processing portion 234 may be implemented in a plurality of chips and/or a plurality of individual components. At least a portion of the radios may be integrated on a single substrate of the chip.

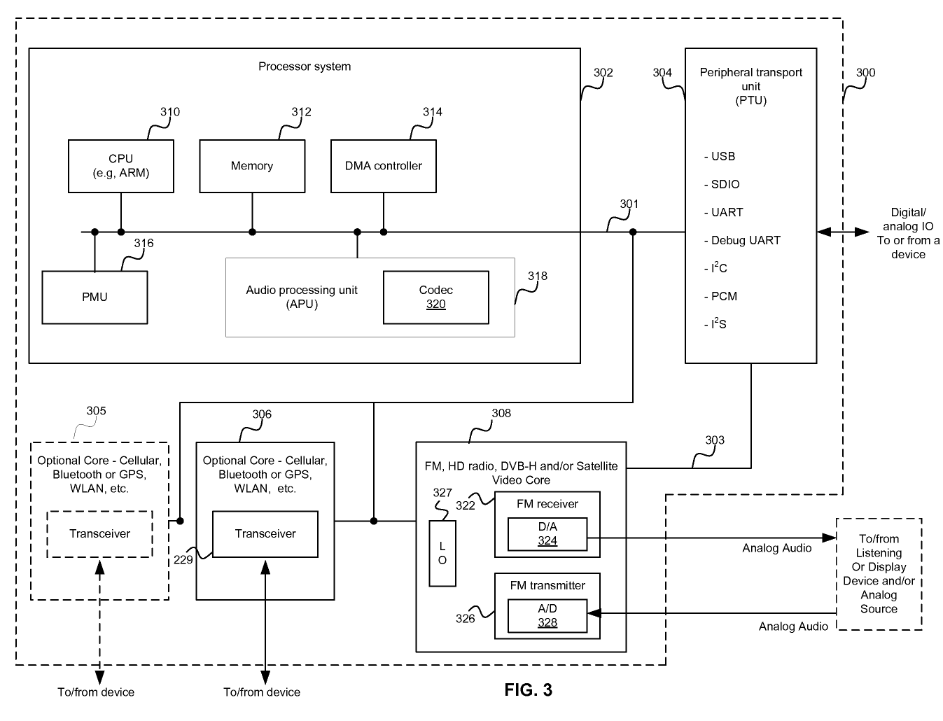

FIG. 3 is a block diagram illustrating an exemplary chip that may be operable to coordinate broadcast and personal communication, in accordance with an embodiment of the invention. Referring to FIG. 3, there is shown the single chip 300 that may comprise a processor system 302, a peripheral transport unit (PTU) 304, one or more optional transceiver cores 305 and 306, a frequency modulation (FM) core 308 with the FM transmitter 326 and the FM receiver 324 integrated into the FM core 308, and a common bus 301.

The processor system 302 may comprise a central processing unit (CPU) 310, a memory 312, a direct memory access (DMA) controller 314, a power management unit (PMU) 316, and an audio processing unit (APU) 318. The APU 318 may comprise a sub-band coding (SBC) codec 320. At least a portion of the components of the processor system 302 may be communicatively coupled via the common bus 301.

The CPU 310 may comprise suitable logic, circuitry, interfaces and/or code that may enable control and/or management operations in the single chip 300. In this regard, the CPU 310 may communicate control and/or management operations to the optional transceiver cores 305 and 306, the FM core 308, and/or the PTU 304 via a set of register locations specified in a memory map. Moreover, the CPU 310 may be utilized to process data received by the single chip 300 and/or to process data to be transmitted by the single chip 300. The CPU 310 may enable processing of data received via the optional transceiver cores 305 and 306, via the FM core 308, and/or via the PTU 304. For example, the CPU 310 may enable processing of A2DP data and may then transfer the processed A2DP data to other components of the single chip 300 via the common bus 301. In this regard, the CPU may utilize the SBC codec 320 in the APU 318 to encode and/or decode A2DP data, for example. The CPU 310 may enable processing of data to be transmitted via the FM core 308, one or more of the optional transceiver cores 305 and 306 and/or via the PTU 304. The CPU 310 may be, for example, an ARM processor or another embedded processor core that may be utilized in the implementation of system-on-chip (SOC) architectures.

The CPU 310 may time multiplex FM data processing operations and data processing operations from another integrated transceiver such as a cellular or Bluetooth transceiver for example. In this regard, the CPU 310 may perform each operation by utilizing a native clock, that is, cellular data processing based on a cellular clock, Bluetooth data processing based on a Bluetooth clock and FM data processing based on an FM clock. The cellular clock, Bluetooth clock and the FM clock may be distinct and may not interact. The CPU 310 may gate the cellular clock, FM clock and the Bluetooth clock and may select the appropriate clock in accordance with the time multiplexing scheduling or arrangement. When he CPU 310 switches between cellular operations and FM operations, at least certain states associated with the cellular operations or with the FM operations may be retained until the CPU 310 switches back.

For example, in the case where the cellular function is not active and is not expected to be active for some time, the CPU 310 may run on a clock derived from the FM core 308. This may eliminate the need to bring in a separate high-speed clock when one is already available in the FM core 308. In a case where the cellular core 306 may be active, for example when the cellular is in a power-saving mode that requires it to be active periodically, the processor may chose to use a clock derived separately from the FM core 308. The clock may be derived directly from a crystal or oscillator input to the cellular core 306, or from a phase locked loop (PLL) in the cellular core 306. While this clocking scheme may provide certain flexibility in the processing operations performed by the CPU 310 in the single chip 300, other clocking schemes may also be implemented.

The CPU 310 may also enable configuration of data routes to and/or from the FM core 308 and/or one or more of the optional transceiver cores 305 and 306. For example, the CPU 310 may configure the FM core 308 so that data may be routed via an I²S interface or a PCM interface in the PTU 304 to the analog ports communicatively coupled to the PTU 304.

The CPU 310 may enable tuning, such as flexible tuning, and/or searching operations in Bluetooth for example, and/or FM communication by controlling at least a portion of the Bluetooth core 306 and/or the FM core 308. For example, the CPU 310 may generate at least one signal that tunes the FM core 308 to a certain frequency. The CPU 310 may configure a path for the audio signal to be processed in the single chip 300. When a station is not found, the CPU 310 may generate at least one additional signal that tunes the FM core 308 to a different frequency to determine whether a station may be found at a new frequency.

The CPU 310 may enable interfacing by a Bluetooth host controller interface (HCI). In this regard, the HCI provides a command interface to the baseband controller and link manager, and access to hardware status and control registers. The HCI may provide a method of accessing the Bluetooth baseband capabilities that may be supported by the CPU 310.

The CPU 310 may comprise suitable logic, circuitry, interfaces and/or code that may be operable to process and/or render broadcast data received from the FM core 308 as well as personal data received from the optional core 306 that may comprise, for example, cellular data. In addition, the CPU 310 may be operable to control processing of broadcast and personal data. In this regard, the CPU 310 may be operable to interleave the broadcast data and personal data and configure a path for listening and/or display of the interleaved broadcast and personal data. In addition, the CPU 310 may configure a path for the interleaved data to a listening and/or display device via an alternate core 305. The alternate core 305 may comprise a Bluetooth transceiver, for example and the listening and/or display device may comprise Bluetooth technology.

The memory 312 may comprise suitable logic, circuitry, interfaces and/or code that may be operable to store the broadcast and/or personal data. In addition, the memory 312 may be utilized to store data that may be utilized by the processor system 302 to control and/or manage operations, for example, interleaving operations of the single chip 300. The memory 312 may also be utilized to store data received by the single chip 300 via the PTU 304 and/or via the FM core 308. Similarly, the memory 312 may be utilized to store data to be transmitted by the single chip 300 via the PTU 304 and/or via the FM core 308. The DMA controller 314 may comprise suitable logic, circuitry, interfaces and/or code that may enable transfer of data directly to and from the memory 312 via the common bus 301 without involving the operations of the CPU 310.

The PTU 304 may comprise suitable logic, circuitry, interfaces and/or code that may enable communication to and from the single chip 300 via a plurality of communication interfaces. In some instances, the PTU 304 may be implemented outside the single chip 300, for example. The PTU 304 may support analog and/or digital communication with at least one port. Digital multimedia and/or audio data may be transferred by a digital interface, for example, inter-IC-sound (I²S), inter-integrated circuit (I²C), pulse code modulation (PCM), universal serial bus (USB), secure digital input/output (SDIO) and/or universal asynchronous receiver transmitter (UART). For example, the PTU 304 may support at least one USB interface that may be utilized for Bluetooth data communication, at least one SDIO interface that may also be utilized for Bluetooth data communication, at least one UART interface that may also be utilized for Bluetooth data communication, and at least one inter-integrated circuit (1²C) bus interface that may be utilized for FM control and/or FM and RDS/RBDS data communication. The PTU 304 may also support at least one PCM interface that may be utilized for Bluetooth data communication and/or FM data communication, for example.

The PTU 304 may also support at least one inter-IC sound (I²S) interface, for example. The I²S interface may be utilized to send high fidelity FM digital signals to the CPU 310 for processing, for example. In this regard, the I²S interface in the PTU 304 may receive data from the FM core 308 via a bus 303, for example. Moreover, the I²S interface may be utilized to transfer high fidelity audio in Bluetooth. For example, in the A2DP specification there is support for wideband speech that utilizes 16 kHz of audio. In this regard, the I²S interface may be utilized for Bluetooth high fidelity data communication and/or FM high fidelity data communication. The I²S interface may be a bidirectional interface and may be utilized to support bidirectional communication between the PTU 304 and the FM core 308 via the bus 303.

The I²S interface may be utilized to send and/or receive FM broadcast data and/or cellular data to an external device such as a coder/decoder (CODEC) and/or other devices such as to speakers, headsets and/or a video display, for example. In this regard, the CPU 310 may control sending of broadcast programs, for example news, music or sports content that may be received via the FM core 308 or video channels to speakers and/or a display via the I²S interface. In addition, during advertisements, the CPU 310 may switch to sending personal communications data, for example, cellular data via the I²S interface to speakers and/or a display.

The transceiver core 306 may, for example, be a Bluetooth core and may comprise suitable logic, circuitry, interfaces and/or code that may enable reception and/or transmission of Bluetooth data. The Bluetooth core 306 may comprise a Bluetooth transceiver 329 that may perform reception and/or transmission of Bluetooth data. In this regard, the Bluetooth core 306 may support amplification, filtering, modulation, and/or demodulation operations, for example. The Bluetooth core 306 may enable interleaved broadcast data and personal data to be transferred from and/or to the processor system 302, the PTU 304, the transceiver core 305 that may communicate via a personal channel such as cellular, and/or the FM core 308 that may handle broadcast channels via the common bus 301, for example.

The FM core 308 may support one or more broadcast channels, for example, an analog and/or digital FM channel, a HD radio channel, a digital video broadcasting-handheld channel (DVB-H) and/or digital video broadcast—satellite handheld (DVB-SH) as well as RDS and/or RDBS information. The FM transmitter 326 may utilize signals based on the reference signal generated by the LO 327. The FM core 308 may enable transmission of data received via the PTU 304 and/or a Bluetooth core 306, for example

The FM core 308 may comprise suitable logic, circuitry, interfaces and/or code that may enable reception and/or transmission of FM data. The FM core 308 may comprise an FM receiver 322, an FM transmitter 326 and a local oscillator (LO) 327. The LO 327 may be utilized to generate a reference signal that may be utilized by the FM core 308 for performing analog and/or digital operations. The FM receiver 322 may handle demodulation, amplification and/or filtering operations, for example. The FM transmitter 326 may handle modulation, amplification and/or filtering operations. Moreover, the FM receiver 322 may receive FM audio data and demodulate the audio data in a digital domain. The demodulated digital audio data may be converted to analog via the D/A converter 324 and analog audio may be output from the chip to a listening device. Also, analog audio may be input from an external device to the FM transmitter 326. The FM transmitter 326 may comprise an analog to digital converter (A/D) 328 that may be utilized to convert analog audio information to a digital signal for modulation in the digital domain prior to FM transmission. The FM core 308 may enable data to be transferred to and/or from the processor system 302, the PTU 304, and/or one or more optional radio cores 306 via the common bus 301 and/or the bus 303, for example.

The FM core 308 may enable radio transmission and/or reception at various frequencies, such as, 400 MHz, 900 MHz, 2.4 GHz and/or 5.8 GHz, for example. The FM core 308 may also support operations at the standard FM band comprising a range of about 76 MHz to 108 MHz, for example.

The FM core 308 may also enable reception of RDS data and/or RBDS data for in-vehicle radio receivers. In this regard, the FM core 308 may enable filtering, amplification, and/or demodulation of the received RDS/RBDS data. The RDS/RBDS data may comprise, for example, information for retuning to a new channel such as a channel spacing offset and one or more alternate channels. The alternate channels may provide advertising for an individual user and/or a plurality of users. For example during reception of a broadcast signal, RDS/RDBS may be utilized to retune the FM core 308 to a different channel during advertisements. In this regard the different channel may be utilized for sending selected advertising that may be received by single user or may be received by a plurality of users of a specified demographic, for example.

The FM core 308 may comprise suitable logic, circuitry, interfaces and/or code that may be operable to receive AM and/or FM HD radio signals that may comprise simulcast analog and digital broadcast signals. In this regard, the FM core 308 may be operable to receive analog signals and/or digital signals that may comprise text information and/or additional digital channels.

In operation, the CPU 310 may comprise suitable logic, circuitry, interfaces and/or code that may be operable to control and/or manage operations in the single chip 300. In this regard, the CPU 310 may communicate control and/or management data to the FM core 308, the one or more optional transceiver cores 305 and/or 306 and/or the PTU 304. Moreover, the CPU 310 may be utilized to process data received by the single chip 300 and/or to process data to be transmitted by the single chip 300. For example, the CPU 310 may enable processing and/or rendering of broadcast data received from the FM core 308. In addition, the CPU 310 may enable processing and/or rendering of personal data received from the optional core 306 that may comprise, for example, cellular data. The CPU 310 may also enable configuration of data routes to and/or from the FM core 308 and/or the optional cores 305 and/or 306. For example, the CPU 310 may configure the FM core 308 and/or one or more of the optional cores 305 and/or 306 so that data may be routed via an I²S interface to a listening device and/or display. In this manner, the CPU 310 may be operable to coordinate delivery of content from a broadcast source and/or from a personal communication source to a listening device and/or a display. In other exemplary embodiments of the invention, the CPU 310 may configure a data path for broadcast and/or personal communication content, to a listening and/or display device via an alternate core 305. The alternate core 305 may comprise a Bluetooth transceiver, for example and the listening and/or display device may comprise Bluetooth technology.

In various embodiments of the invention, the broadcast core 308 may be operable to receive broadcast data that may be sent to a large population of users and receive personal data such as advertising content that may be directed to an individual or a specified group of users. In this regard, the broadcast core 308 may be operable to receive multiplexed channels. The personalized data may be delivered via multiplexed channels, for example, time multiplexed channels, orthogonal code channels and/or orthogonal frequency channels. For example, the broadcast data may be received by the broadcast core 308 and by a plurality of other users via a one specified channel. During broadcasting, the broadcaster may switch from broadcasting to a large population of users to sending one or more streams of personalized data to individuals and/or to groups of users. Each individual user or group of users may receive only a stream which is directed to them. The personalized data may be delivered to individuals via a multiplexed channel, for example, a time multiplexed channel, and an orthogonal code multiplexed channel and/or an orthogonal frequency channel.

Broadcast data and/or personal content data may be protected during transmission and/or reception such that the data may be accessed only by users and/or subscribers that have permission to do so. For example, the broadcast data and/or the personal may be encrypted and/or scrambled prior to transmission. Authorized users may be issued one or more keys or secure data that may enable deciphering, decrypting and/or descrambling the received data. In this regard, the keys and/or secure data may be transmitted to the chip 300 via a personal communication channel to one of the optional cores 305 and 306, for example.

FIG. 4 is a block diagram illustrating an exemplary user device that is operable to coordinate broadcast radio and personal radio communication, in accordance with an embodiment of the invention. Referring to FIG. 4, there is shown a communication device 410 comprising a speaker 412, a processor 414, a visual display 416, a user input interface 418, a memory 420, an FM transmitter and/or receiver 422 and one or more optional transmitter and/or receiver 424.

The communication device 410 may comprise suitable logic, circuitry, interfaces and/or code that may be operable to receive signals within an FM frequency band. The communication device 410 may comprise, for example, a cellular phone, a television and/or television set-top-box, a computing device, a car radio and/or a government or business communication system. The communication device 410 may be operable to demodulate and decode multimedia and/or audio signals. The communication device 410 may be capable of receiving manual input from a user such as channel selection. It may also display information for the user with regard to channel selection and RDS/RBDS data.

The speaker or listening device 412 may be suitable for converting electrical output from the receiver device to appropriate audio acoustical waves for a listener. The speaker or listening device may be communicatively coupled with the processor 414.

The processor 414 may comprise suitable logic, circuitry, interfaces and/or code that may enable management of scanning, detecting and tuning operations, for example, for a tuning a receiver in the FM transmitter and/or receiver 422. The managed operations may utilize a plurality of inputs comprising user input, RDS, RBDS, GNSS data such as location information, RSSI levels, carrier error and/or programmed algorithms. For example, based on one or more of the plurality of inputs, the processor 414 may be operable to determine when to switch between a broadcast channel and a personal channel and/or from a personal channel to a broadcast channel. The processor 414 may also be enabled to process multimedia and/or audio data. The processor 414 may be communicatively coupled to the FM transmitter and/or receiver 422, the memory 420, the display 416 and the speaker or listening device 412.

The display 416 may comprise suitable logic, circuitry, interfaces and/or code to display visual information for the user. The communication device 410 may display received video signals. In addition, the communication device 410 may display operational conditions of the device, program information and/or channel information for example. The display 416 may be communicatively coupled with the processor 414 and the memory 420.

The user input interface 418 may comprise a suitable interface for manual input of information that may be utilized by the communication device 410 to make channel selections or input configuration parameters. The user input may comprise a voice recognition system where input may be spoken by a user and converted to digital information for use as parameters in communication device 410 operations. The user interface 418 may be utilized to respond to content such as advertisements via a personal channel. In addition, the user input interface 418 may be utilized to set user preferences, for example, preferences with regard to a type of advertising or news programming to receive.

The memory 420 may comprise suitable logic, circuitry and/or code to store and retrieve information that supports scanning, detecting and tuning operations within the communication device 410. The memory 420 may store, for example: user input, a channel database for broadcast and/or personal communication channels, RDS/RBDS data, GNSS location information, RSSI levels, carrier error and/or programmed algorithms. The memory 420 may store information that maps personal communication channels with user data and/or geographic location for example. The memory 420 may store processed multimedia and/or audio data as well.

The FM transmitter and/or receiver 422 may comprise suitable logic, circuitry, interfaces and/or code to demodulate and decode FM signals that may comprise multiplexed channels. The FM transmitter and/or receiver 422 may be coupled with one or more antennas and may receive transmissions from a broadcast source and/or a personal communication source. The FM transmitter and/or receiver 422 may be communicatively coupled with the processor 414, the memory 420, and an FM antenna 426. In instances when the communication device 410 comprises an optional transmitter and/or receiver 424, for example a cellular, a Bluetooth, a GNSS or a wireless local area network (WLAN) transmitter and/or receiver, the FM transmitter and/or receiver 422 and the optional transmitter and receiver 424 may each have their own antenna or may share one or more antennas. In this regard, the FM transmitter and/or receiver 422 and the alternate band transmitter and/or receiver signals may be decoupled in a diplexer and/or duplexer between the receivers and shared antenna 426. Additional optional alternate technology transceivers may share antennas in a similar manner.

One or more optional transmitters and/or receivers such as the optional transmitter and/or receiver 424 may facilitate switching between receiving broadcast and personal communications. The optional transmitter and/or receiver 424 may comprise one or more of a plurality of technologies, for example, cellular, Bluetooth, WLAN, RFID, infrared or a wire-line connection. In this regard, the optional transmitter and/or receiver 424 may provide information that may be utilized to determine which personal channel to demodulate. For example, location information from a GNSS receiver may indicate which personal channel to switch to for locally directed advertizing content. In other embodiments of the invention, the optional transmitter and/or receiver 424 may provide an alternate technology that may transmit and/or receive personal communication directed to a specific user of the communication device 410. For example, the optional transmitter and/or receiver 424 may comprise a cellular transmitter and/or receiver which may provide the advertising content for the specified user. In this regard, the processor 414 may switch from enabling broadcast communication received via the FM transmitter and/or receiver 422 to enable directed or personal communication via the optional transmitter and/or receiver 224.

One or more optional transmitters and/or receivers such as the optional transmitter and/or receiver 424 may be communicatively coupled with the processor 414, the memory 420 and an antenna. The optional transmitter and/or receiver 424 may utilize a simplex or duplex antenna. The optional transmitter and/or receiver 424 and the FM transmitter and/or receiver 422 may each have their own antenna or may share a wide band or dual band antenna. In this regard, the FM transmitter and/or receiver 422 signals and the alternate band transmitter and/or receiver signals may be decoupled in a diplexer and/or duplexer between the receivers and shared antenna 426. Additional optional alternate technology transmitters and receivers may share antennas in a similar manner.

The personal communication data may be communicated to the FM transmitter and/or receiver 422 via an FM channel, a sideband or via an alternate technology frequency band such as a cellular or WLAN channel, for example. The communication device 410 may tune to the personal communication channel accordingly.

In operation, the communication device 410 may receive a broadcast via the FM transmitter and/or receiver 422 comprising, for example, multimedia data. In addition, the communication device 410 may receive multimedia data directed to a user of the device via the optional transmitter and/or receiver 424. During display of the broadcast multimedia data, the user directed multimedia may be substituted in the display stream and/or overlaid with the broadcast multimedia data in the display stream. For example, when the broadcast and user directed multimedia data comprise video, the personal multimedia data may be displayed simultaneously with the broadcast multimedia data. In this regard, advertising that may be broadcast nationwide may be overlaid with pertinent local information such as a local address for a store that may be part of national chain of stores. In other embodiments of the invention, broadcast video received via the FM transmitter and/or receiver 422 may be displayed while user directed audio received via the optional transmitter and/or receiver 424 may be played over the speakers 412 simultaneously.

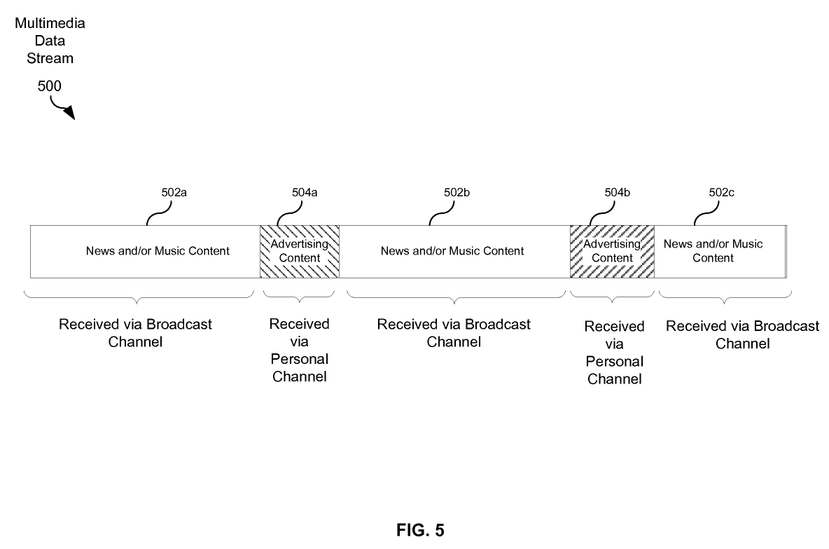

FIG. 5 is a block diagram illustrating an exemplary stream of interleaved broadcast channel data and personal channel data, in accordance with an embodiment of the invention. Referring to FIG. 5, there is shown a stream of multimedia data 500, a plurality of broadcast channel data segments 502a, 502b and 502c and a plurality of personal channel data segments 504a and 504b.

The broadcast channel data segments 502a, 502b and/or 502c may be received by a user device via a broadcast channel, for example, a broadcast cellular channel, a broadcast FM radio channel, a broadcast satellite, terrestrial or cable TV channel and/or a broadcast Internet channel. The personal channel data segments 504a and 504b may be received by the user device via a personal channel, for example, a cellular channel, a personal satellite, terrestrial or cable Radio or TV channel and/or a personal Internet channel.

In operation, the broadcast channel may deliver content to the user such as music, news or drama. The personal channel may deliver content intended for a specified individual or specified device or a specified group of individuals or devices. For example, the content delivered via the personal channel may comprise advertising and/or news content that may be directed to the specified recipient. The content delivered via the personal channel may be determined based on a user's location or personal preferences for example. The user device may interleave the received broadcast content and personal content within the stream of multimedia data 500 and may play or display the interleaved content without user intervention. In various embodiments of the invention, broadcast advertising that may be received during the personal channel advertising segments 504a and/or 504b may be ignored by the device.

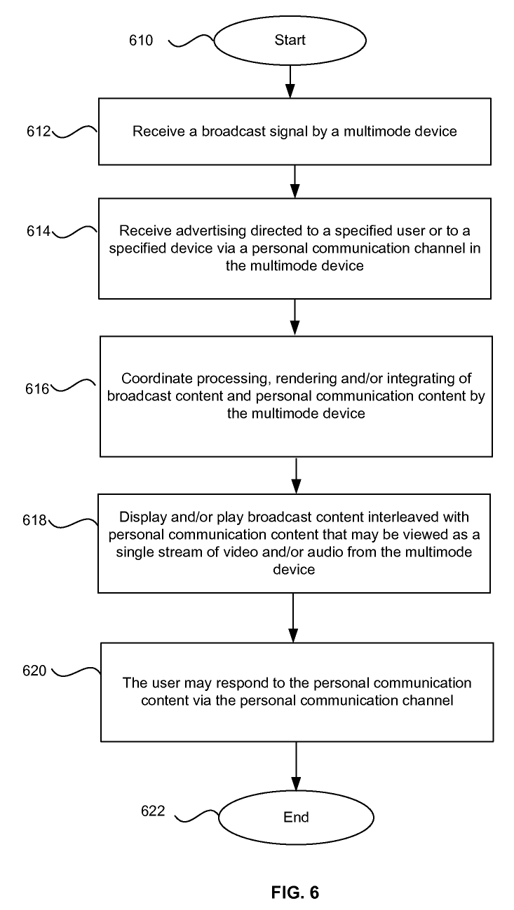

FIG. 6 is a flow chart illustrating exemplary steps for integrating broadcast content and personal communication content in a multimode device, in accordance with an embodiment of the invention. The exemplary steps may begin with start step 610. In step 612, a multimode device, for example, the cellular phone 102 may receive a broadcast signal. For example, the broadcast signal may comprise a news program. In step 614, the multimode device may receive advertising content directed to a specified user or to a specified device via a personal communication channel. For example, the advertising content may be directed to a user based on the user's location or demographics of the user. In step 616, the multimode device may coordinate processing, rendering and/or integrating of the broadcast content and the personal communication content. For example, the multimode device may interleave broadcast news content and personal communication advertising content. In step 618, the multimode device may display and/or play broadcast content interleaved with personal communication content. The interleaved content may be viewed as a single stream of video and/or audio from the multimode device. In step 620, a user of the multimode device may respond to the personal communication content via the personal communication channel. For example, the user may respond to advertising, make a purchase and/or modify user preferences via the personal channel. Step 620 may be an end of the exemplary steps.

In an embodiment of the invention, one or more processors or circuits in a communication device, for example the processor 414 in the communication device 410, the processor 236 in the single chip 230 and/or one or more processors in the processor system 302 in the single chip 300, may receive broadcast signals and personal communication signals. The personal communication signals may be unicasted to the communication device. The one or more processors or circuits may interleave and/or combine broadcast content for example, broadcast channel data segments 502a, 502b and/or 502c from the broadcast signals with personal communication content, for example, personal channel data segments 504a and 504b from the received personal communication signals. In this regard, portions of the personal communication content may be inserted in the broadcast content. The interleaved and/or combined broadcast content and personal content, for example, the stream of multimedia data 500 may be displayed and/or played as a single stream of video and/or audio via the speakers 412 and/or display 416. The interleaved and/or combined content may be transmitted to as second user device, for example, via a Bluetooth interface to be played by the second device.

The personal communication content may be determined and/or selected based on a location of the communication device and/or based on demographics of a user and/or a profile associated with the user. The broadcast signals may be received via one or more of a digital and/or analog terrestrial radio band and/or television channel, a satellite radio and/or television channel, a cable radio and/or television channel, and Internet radio and/or video channel. For example, the broadcast signals may be received via the radio portion 232 of the single chip 230, the FM receiver 422 in the communication device 410 or the FM core 308 in the single chip 300. The personal communication signals may be received via one or more of a cellular channel, a personal cable channel, a personal satellite channel and/or a personal Internet channel, for example. For example, the personal communication signals may be received via the radio portion 232 of the single chip 230, the optional receiver 422 in the communication device 410 or via one or more of the optional cores 305 and/or 306 in the single chip 300. Exemplary broadcast content may comprise a television and/or radio program, for example, a music or news program such as the broadcast channel data segments 502a, 502b and/or 502c. Exemplary personal communication content may comprise advertising directed to an individual user or a group of users, such as the personal channel data segments 504a and 504b. The user may be able to transmit feedback and/or a response via the personal communication signals, for example, via the optional transmitter 422 in the communication device 410 or via one or more of the optional cores 305 and/or 306 in the single chip 300.

In various embodiments of the invention, broadcast signals and/or personal communication signals may be received and/or deciphered in the communication device 410 or the single chip 300, for example. Deciphering keys and/or information may be received via the personal communication signals. Moreover, exemplary embodiments of the invention may be operable to monitor and/or count advertisements received via the personal communication signals, for example, by the processor 414 in the communication device 410, the processor 236 in the single chip 230 and/or one or more processors in the processor system 302 in the single chip 300.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for synergistic integration of broadcasting and personal channels.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors or circuits in a communication device, functions comprising:
receiving of broadcast signals and personal communication signals, wherein said personal communication signals are unicasted to said communication device;
interleaving and/or combining broadcast content from said broadcast signals with personal communication content from said received personal communication signals, wherein portions of said personal communication content is inserted in said broadcast content; and
displaying said interleaved and/or said combined broadcast content and said personal communications content as a single stream of video and/or audio.

2. The method according to claim 1, comprising determining said personal communication content based on a location of a device.

3. The method according to claim 1, comprising determining said personal communication content based on demographics of a user and/or a profile associated with said user.

4. The method according to claim 1, comprising receiving said broadcast signals via one or more of a digital and/or analog terrestrial radio band and/or television channel, a satellite radio and/or television channel, a cable radio and/or television channel, a cellular broadcast channel and Internet radio and/or video channel.

5. The method according to claim 1, comprising receiving said personal communication signals via one or more of a cellular channel, a personal cable channel, a personal satellite channel and/or a personal Internet channel.

6. The method according to claim 1, wherein said broadcast content comprises a television and/or radio program.

7. The method according to claim 1, wherein said personal communication content comprises advertising directed to an individual user or a group of users.

8. The method according to claim 1, comprising transmitting user feedback and/or response via said personal communication signals.

9. The method according to claim 1, comprising receiving and/or deciphering said received broadcast signals and/or said personal communication signals wherein one or more keys for said deciphering are received via said personal communication signals.

10. The method according to claim 1, comprising monitoring and/or counting advertisements received via said personal communication signals.

11. The method according to claim 1, comprising transmitting said interleaved and/or said combined broadcast content and said personal communications content as a single stream of video and/or audio to a second user device.

12. A system for communication, the system comprising:
one or more processors or circuits for use in a communication device, wherein said one or more processors are operable to:
receive of broadcast signals and personal communication signals, wherein said personal communication signals are unicasted to said communication device;
interleave and/or combine broadcast content from said broadcast signals with personal communication content from said received personal communication signals, wherein portions of said personal communication content is inserted in said broadcast content; and
display said interleaved and/or said combined broadcast content and said personal communications content as a single stream of video and/or audio.

13. The system according to claim 12, wherein said one or more circuits are operable to determine said personal communication content based on a location of a device.

14. The system according to claim 12, wherein said one or more circuits are operable to determine said personal communication content based on demographics of a user and/or a profile associated with said user.

15. The system according to claim 12, wherein said one or more circuits are operable to receive said broadcast signals via one or more of a digital and/or analog terrestrial radio band and/or television channel, a satellite radio and/or television channel, a cable radio and/or television channel, a cellular broadcast channel and Internet radio and/or video channel.

16. The system according to claim 12, wherein said one or more circuits are enabled to receive said personal communication signals via one or more of a cellular channel, a personal cable channel, a personal satellite channel and/or a personal Internet channel.

17. The system according to claim 12, wherein said broadcast content comprises a television and/or radio program.

18. The system according to claim 12, wherein said personal communication content comprises advertising directed to an individual user or a group of users.

19. The system according to claim 12, wherein said one or more circuits are operable to transmit user feedback and/or response via said personal communication signals.

20. The system according to claim 12, wherein said one or more circuits are operable to receive and/or decipher said received broadcast signals and/or said personal communication signals wherein one or more keys for said deciphering are received via said personal communication signals.

21. The system according to claim 12, wherein said one or more circuits are operable to monitor and/or count advertisements received via said personal communication signals.

22. The system according to claim 12, wherein said one or more circuits are operable to transmit said interleaved and/or said combined broadcast content and said personal communications content as a single stream of video and/or audio to a second user device.
